(19) United States
(12) Patent Application Publication
(10) Pub. No.: US 2024/0347988 A1
(43) Pub. Date: Oct. 17, 2024

(54) COAXIAL BOARD CONNECTOR WITH AN IMPROVED INNER CONDUCTOR

(71) Applicants: FUDING PRECISION COMPONENTS (SHENZHEN) CO., LTD., Shenzhen (CN); FOXCONN INTERCONNECT TECHNOLOGY LIMITED, Grand Cayman (KY)

(72) Inventors: DE-JIN CHEN, Shenzhen (CN); Teng Huang, Shenzhen (CN); Yu-San Hsiao, New Taipei (TW); Shih-Wei Hsiao, New Taipei (TW)

(21) Appl. No.: 18/632,833

(22) Filed: Apr. 11, 2024

(30) Foreign Application Priority Data
Apr. 12, 2023 (CN) 202310415556.6

(51) Int. Cl. H01R 24/50; H01R 9/05; H01R 12/71; H01R 101/00

(52) U.S. Cl. CPC H01R 24/50; H01R 9/0515; H01R 12/716; H01R 2101/00

(57) ABSTRACT

A coaxial board connector includes: a first insulator; a first inner conductor having an upper mating portion and a lower first connecting portion; a first outer conductor having a lower third connecting portion; a second insulator; a second inner conductor having an upper second connecting portion and a lower tail portion; and a second outer conductor and having an upper fourth connecting portion and a lower fixing portion, wherein the first insulator sits on the second insulator and has an arc-shaped lower face, the first connecting portion is in contact with the second connecting portion and the third connecting portion is in contact with the fourth connecting portion, and the first connecting portion is able to sway relative to the second connecting portion and the third connecting portion is able to sway relative to the third connecting portion under the action of the arc-shaped lower face.

### BACKGROUND OF THE INVENTION

### Field of the Invention

The present invention relates to a coaxial board connector.

### Description of Related Arts

China Patent No. 218005411U discloses a floating electrical connector which includes a floating upper shell, a fixed lower shell, and an insulator retained with conductive terminals therein. The lower shell is fixedly mounted on a printed circuit board and the upper shell is engaged with the lower shell and can sway relative to the lower shell. The insulator is retained in the upper shell and each conductive terminal includes a soldering tail to be mounted on the printed circuit board at a bottom end thereof. The soldering tail has an upper end which is flexible to absorb the swinging deformation of the conductive terminal. Since the soldering tails are soldered to the printed circuit board, the swing range of the conductive terminals is limited, which may not meet the offset mating requirements of coaxial connector at various angles.

Therefore, it is desired to provide a coaxial board connector with an improved inner conductor.

### SUMMARY OF THE INVENTION

An object of the present invention is to provide a board connector with an improved inner contact.

To achieve the above object, a board connector comprises: a first insulator; a first inner conductor being retained in the first insulator and comprising an upper mating portion and a lower first connecting portion exposed out of the first insulator; a first outer conductor being fixed at an outside of the first insulator and comprising a lower third connecting portion; a second insulator; a second inner conductor being retained in the second insulator and comprising an upper second connecting portion and a lower tail portion for fixing on a printed circuit board; and a second outer conductor being fixed at an outside of the second insulator and comprising an upper fourth connecting portion and a lower fixing portion for fixing on the printed circuit board, wherein the first insulator sits on the second insulator and has an arc-shaped lower face, the third connecting portion is in contact with the fourth connecting portion, and the first connecting portion is able to sway relative to the second connecting portion and the third connecting portion is able to sway relative to the third connecting portion under the action of the arc-shaped lower face.

Other advantages and novel features of the invention will become more apparent from the following detailed description of the present embodiment when taken in conjunction with the accompanying drawings.

### BRIEF DESCRIPTION OF THE DRAWING

FIG. 1 is a top perspective view of a coaxial connector assembly including a board connector and a device connector disconnecting from each other;

FIG. 2 is an exploded perspective view of an upper part of the board connector in FIG. 1;

FIG. 3 is an exploded perspective view of a lower part of the board connector in FIG. 1;

FIG. 4 is a cross-sectional view of the board connector on a circuit board taken along line A-A in FIG. 1;

FIG. 5 is a cross-sectional view of the device connector retained in a device case taken along line B-B in FIG. 1;

FIG. 6 is an exploded perspective view of the device connector in FIG. 1; and

FIG. 7 is a cross-sectional view of the coaxial connector assembly, wherein the board connector and the device connector are mated with each other.

### DETAILED DESCRIPTION OF THE PREFERRED EMBODIMENT

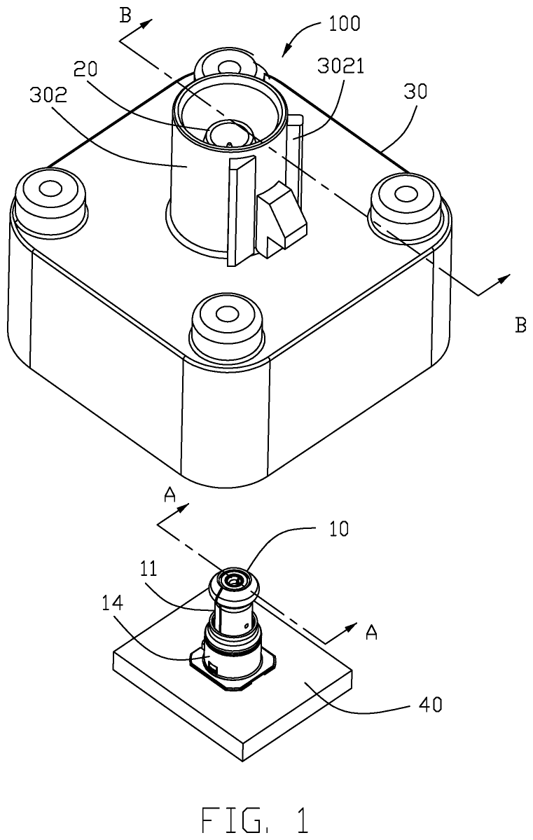

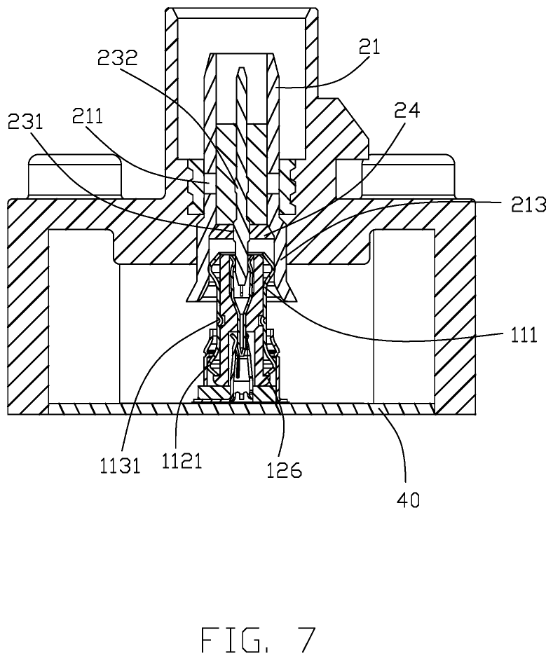

Referring to FIGS. 1, 4, and 7, a floating coaxial connector assembly 100 used in a vehicle for transmitting signals from cameras is illustrated. In a field of vehicle connectors, a Fakra plug connector is usually retained in a device case and is named as a device connector, the receptacle Fakra connector is fixed on a circuit board and is named as a board connector. The coaxial connector assembly 100 in this embodiment includes a board connector 10 and a device connector 20 embedded in a device case 30. When the device connector 20 and the board connector 10 are mated as shown in FIG. 7, the board connector 10 together with a circuit board 40 is received in the device case 30. As the board connector 10 is a floating connector, it can slightly float relative to the mated device connector 20 to adapt for vehicle vibration.

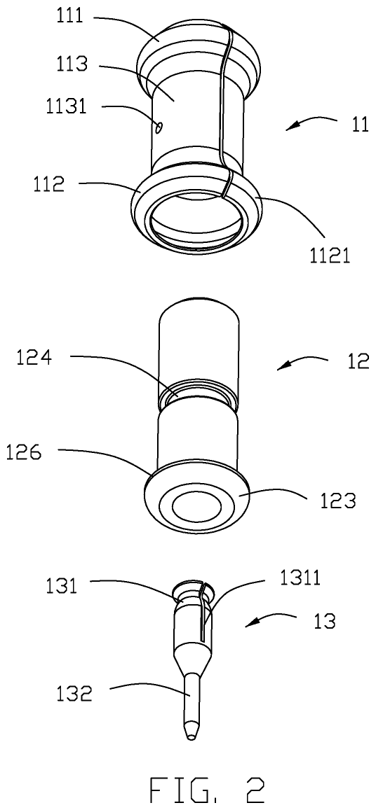

Referring to FIGS. 2-4, the board connector 10 comprises a first outer conductor 11, a first insulator 12, a first inner conductor 13, a second outer conductor 14, a second insulator 15, and a second inner contact 16. The first inner contact 13 is retained in the first insulator 12. The first insulator 12 together with the first inner contact 13 is received and fixed in the first outer conductor 11. The second inner conductor 16 is retained in the second insulator 15. The second insulator 15 together with the second inner conductor 16 is received and retained in the second outer conductor 14. The first inner conductor 13 comprises a mating portion 131 at an upper end thereof and a first connecting portion 132 opposite to the mating portion 131. The second inner conductor 16 comprises a second connecting portion 161 adapted for connecting with the first connecting portion 132 and a tail portion 162. The first outer conductor 11 comprises a third connecting portion 112 near the first connecting portion 132, the second outer conductor 14 comprises a fourth connecting portion 141 and a fixing portion 142, the tail portion 162 and the fixing portion 142 are fixed on the circuit board 40. The first insulator 12 sits on the second insulator 15 with a flange 126 which has an arc face 123. The third connecting portion 112 has a protruding portion 1121 which electrically resists on an inside of the second outer conductor 14. The protruding portion 1121 of the first outer conductor 11 can sway relative to the second outer conductor 14. The flange 126 supports the protruding portion 1121 upwardly to prevent it from deforming during long-term sway. As the first inner conductor 13 and the insulator 12 are fixed in the first outer conductor 11 and the second inner conductor 16 and the second insulator 15 are fixed in the second outer conductor 14, the first insulator swaying relative to the second insulator 15 with the arc surface 123 drives the first connecting portion 132 to sway relative to the second connecting portion 161 as well as the third connecting portion 112 to sway relative to the fourth connecting portion 141. Preferably, in other embodiments, the third connecting portion 112 or the protruding portion 1121 can be provided with plural notches (not labelled) to enable the protruding portion 1121 be elastically abutted with the inside of the second outer conductor 14.

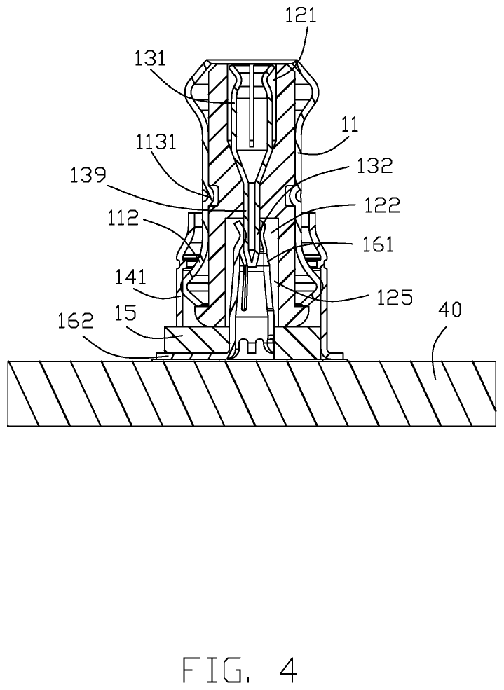

Referring to FIG. 4, the second outer conductor 14 surrounds around the second insulator 15 and the second inner conductor 16, thereby defining a connecting cavity thereamong, the connecting cavity is located above the second insulator 15, the second inner conductor is exposed to the connecting cavity. The first insulator 12 has an upper receiving cavity 121 going through an upper face thereof and a lower receiving cavity 122 going through a lower face thereof. The mating portion 131 is received in the upper receiving cavity 121 and the first connecting portion 132 is exposed to the lower receiving cavity 122. The second connecting portion 161 extends into the lower receiving cavity 122 and electrically connects with the first connecting portion 132. Preferably, the second connecting portion 161 comprises plural elastic arms 1611 which are distributed circumferentially and form an inserting hole for receiving the first connecting portion 132. A gap 125 is defined between the plural elastic arms 1611 and the inside of the lower receiving cavity 122 for providing the elastic arms 1611 a space to deform.

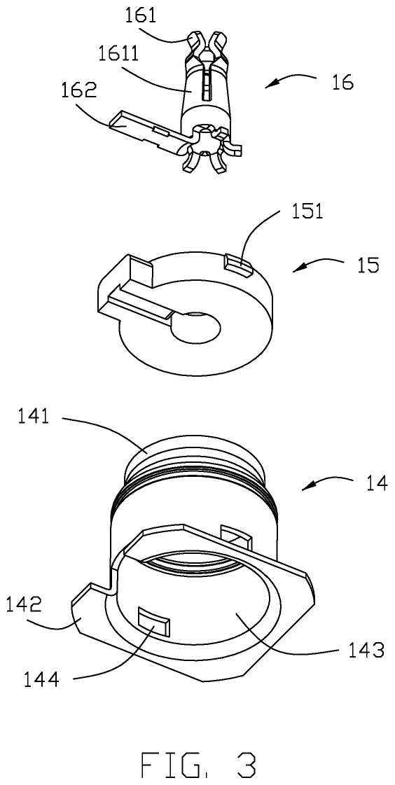

Referring to FIGS. 3-4, preferably, the second insulator 15 and the second inner conductor 16 are integrally injection molded to ensure that they can be mounted to the circuit board 40 coaxially. The second outer conductor 14 has plural locking holes 144 and the second insulator 15 has plural protruding bumps 151 which are received in corresponding locking holes 144. The tail portion 162 extends out from the second insulator 15 downwardly and is fixed on the circuit board 40. In order to enable the first inner conductor 13 sway to the second inner conductor 16 in a predetermined angle, a length of the second connecting portion 161 extends into the lower receiving cavity 122 is longer than that of the first connecting portion 132 exposed to the lower receiving cavity 122. In addition, the length of the second connecting portion 161 extends into the lower receiving cavity 122 is more than two times that of the second inner conductor 16 embedded in the second insulator 15.

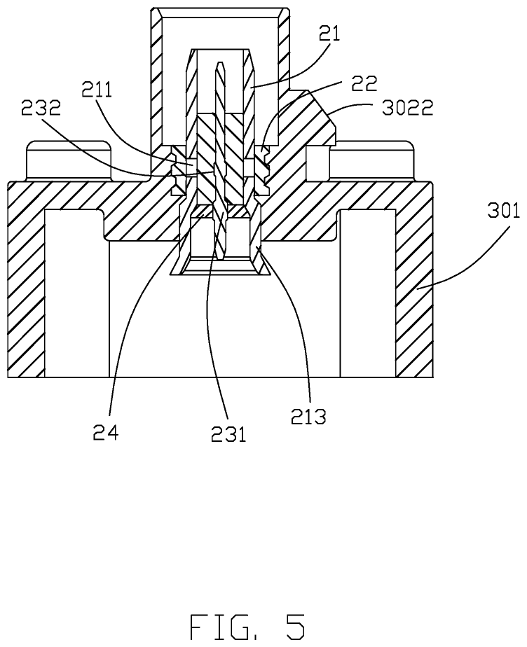

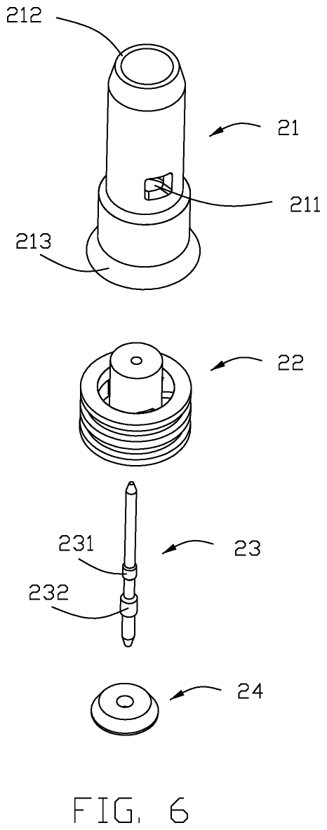

Referring to FIGS. 1 and 5-6, the device connector 20 retained in the device case 30 comprise a third inner conductor 23, a third outer conductor 21 surrounding the third inner conductor 23 and third insulator 22 between the third inner conductor 23 and the third outer conductor 21. The third outer conductor 21 includes an upper tube 212 and a lower tube 213 with a larger diameter than that of the upper tube 212. The third outer conductor 21 is fixed in the device case 30 by a fixing ring (not labeled) between third outer conductor 21 and the device case 30, the fixing ring is integrally formed with the third insulator 22 by injection molding to unite third inner conductor 23, the third outer conductor 21 and the device case 30 as a whole. The third insulator 22 is formed by molding material that flows into the upper tube 212 from the molding material the device case 30 through an opening 211. That is, the molding material is injected in the upper tube 212 first, then, the molding material flows into the third outer conductor 21 through the opening 211. The molding material in the upper tube 212 forms the third insulator 22 and the material between the third outer conductor 211 and the upper tube 212 forms the fixing ring. A seal 24 is provided in the third outer conductor 21 below the third insulator 22. The device case 30 has a base portion 301 and tubular inserting portion 302 extending upward from the base portion 301. The inserting portion 302 is provided with a buckle 3022 and plural guiding ribs 3021.

Referring to FIGS. 4, 5, and 7, the first outer conductor 11 comprises an upper or fifth connecting portion 111. When the board connector 10 is inserted into the device connector 20, the upper connecting portion 111 goes into the third outer conductor 21 from the lower tube 213 and can sway relative to the lower tube 213 under the action of the arc surface 123 to adjust an mating angle between the connecting portion 111 and the lower tube 213. In this embodiment, the mating portion 131 is tubular and comprises a plurality of elastic arms 1311 distributed circumferentially and forms a mating hole. The elastic arms 1311 can deform in the gap 125 when the first inner conductor 13 together with the first insulator 12 sway with the arc surface 123 under the action of an inserting force of the third inner conductor 23, to make stable high-frequency signal transmission between the board connector 10 and the device connector 20. Preferably, the connecting portion 111 has plural slots distributed circumferentially to increase its elasticity, thus, the connecting portion 111 can elastically abut on the inside of the third outer conductor 21.

Referring to FIGS. 4, 5, and 7, a signal transmission path is formed by the second inner conductor 16 and the first inner conductor 13 inserted into it, and the signal transmission path forms a signal transmission loop with a transmission path formed by the first outer conductor 11 and the second outer conductor 14. Preferably, a main portion 113 of the first outer conductor 11 is a hollow column by which signals can be transmitted vertically to make effective and stable shielding. Both the mating portion 131 and the second inner conductor 16 are tubular and have a substantially same diameter. In order to fix the first outer conductor 11 firmly with the first insulator 12, the first insulator is provided with a ring of groove 124, the first outer conductor 11 has plural convex hulls 1131 buckled in the groove 124. The convex hulls 1131 and the groove 124 are near a fixing portion 139 embed in the first insulator 12 between the mating portion 131 and the first connecting portion 132 in an upper-lower direction. The third inner conductor 23 and the third outer conductor 21 are coaxially arranged so that signals in the device connector 20 are transmitted vertically. To make the third inner conductor 23 retained in the third outer conductor 21 more firmly and change the impedance thereof, the third inner conductor 23 has a ring of first flange 231 and a ring of second flange 232. The first flange 231 is at the junction of the upper tube 212 and the lower tube 213 surrounding it and the second flange 232 is near the opening 211 of the third outer conductor 21. The impedance of the floating connector assembly 100 is about 50 52 when the device connector 20 and the board connector 10 are mated, and the floating connector assembly 100 can transmit 6-9 G high-frequency signals.

Although the present invention has been described with reference to particular embodiments, it is not to be construed as being limited thereto. Various alterations and modifications can be made to the embodiments without in any way departing from the scope or spirit of the present invention as defined in the appended claims.

1. A coaxial board connector comprising:
a first insulator;
a first inner conductor being retained in the first insulator and comprising an upper mating portion and a lower first connecting portion exposed out of the first insulator;
a first outer conductor being fixed at an outside of the first insulator and comprising a lower third connecting portion;
a second insulator;
a second inner conductor being retained in the second insulator and comprising an upper second connecting portion and a lower tail portion for fixing on a printed circuit board; and
a second outer conductor being fixed at an outside of the second insulator and comprising an upper fourth connecting portion and a lower fixing portion for fixing on the printed circuit board;
wherein the first insulator sits on the second insulator and has an arc-shaped lower face, the first connecting portion is in contact with the second connecting portion and the third connecting portion is in contact with the fourth connecting portion, and the first connecting portion is able to sway relative to the second connecting portion and the third connecting portion is able to sway relative to the third connecting portion under the action of the arc-shaped lower face.

2. The coaxial board connector as claimed in claim 1, wherein the first insulator has a lower receiving cavity through a lower face thereof, the first connecting portion is exposed to the lower receiving cavity, the second connecting portion extends into the lower receiving cavity to connect with the first connecting portion.

3. The coaxial board connector as claimed in claim 2, wherein the first insulator has an upper receiving cavity through an upper face thereof, the first inner conductor comprises a mating portion received in the upper receiving cavity, the first connecting portion is of a needle shape, and the mating portion defines a mating hole.

4. The coaxial board connector as claimed in claim 1, wherein the second outer conductor is retained around the second insulator to define a connecting cavity above the second insulator, and the third connecting portion and the lower portion of the first insulator are received in the connecting cavity.

5. The coaxial board connector as claimed in claim 2, wherein a length of the second connecting portion extending into the lower receiving cavity is larger than a length of the first connecting portion exposed to the lower receiving cavity.

6. The coaxial board connector as claimed in claim 2, wherein a length of the second inner conductor extending into the lower receiving cavity is two times more than a length of the second inner conductor embedded in the second insulator.

7. The coaxial board connector as claimed in claim 2, wherein the first connecting portion is of a needle shape, the second connecting portion has plural elastic arms which are spaced from an inside of the lower receiving cavity.

8. The coaxial board connector as claimed in claim 1, wherein the first insulator has a supporting portion protruding circumferentially and the arc-shaped lower face is formed on the supporting portion, the third connecting portion bulges in radial directions and form a protruding portion with an arc-shaped cross section, and the second insulator supports the protruding portion upwardly.

9. The coaxial board connector as claimed in claim 1, wherein the first insulator has a ring of groove, and the first outer shell has plural convex hulls buckled in the groove.

10. A coaxial board connector comprising:
an upper unit comprising a first insulator having an upper receiving cavity and a lower receiving cavity, a first inner conductor retained in the first insulator and comprising a mating portion extending in the upper receiving cavity and a first connecting portion extending into the lower receiving cavity, and a first outer conductor fixed around an outside of the first insulator and comprising a third connecting portion; and
a lower unit comprising a second insulator, a second inner conductor retained in the second insulator and comprising a second connecting portion, and a second outer conductor retained around an outside of the second insulator and defining a connecting cavity above the second insulator, the second outer conductor comprising a fourth connecting portion;
wherein the second connecting portion is received in the lower receiving cavity and connects with the first connecting portion, the third connecting portion and a lower part of the first insulator are received in the connecting cavity, and the third connecting portion is limited in an up-to-down direction by the fourth connecting portion and is able to sway in a radial direction.

11. The coaxial board connector as claimed in claim 10, wherein the first insulator has a tumbler lower face siting on the second insulator.

12. The coaxial board connector as claimed in claim 10, wherein the second connecting portion has plural elastic arms to define an inserting hole, and the first connecting portion is inserted into the inserting hole.

13. The coaxial board connector as claimed in claim 10, wherein the first connecting portion is of a needle shape.

14. The coaxial board connector as claimed in claim 10, wherein the third connecting portion has a V-shaped portion, and the V-shaped portion has a peak portion abutting against an inside of the fourth connecting portion and a free end bearing against the first insulator.

15. The coaxial board connector as claimed in claim 10, wherein the fourth connecting portion has a rib ring at an inside thereof, and the rib ring is located above and confines the peak portion.

16. A coaxial connector assembly comprising:
a printed circuit board;
a coaxial board connector mounted on the printed circuit board and comprising:
a first insulator with a upper receiving cavity through an upper face thereof and a lower receiving cavity through an a lower face thereof;
a first inner conductor retained in the first insulator and comprising a first connecting portion exposed in the lower receiving cavity and a mating portion received in the upper receiving cavity;
a first outer conductor fixed around an outside of the first insulator and comprising a third connecting portion;
a second insulator;
a second inner conductor retained in the second insulator and comprising a second connecting portion;
a second outer conductor fixed around an outside of the second insulator, and comprising a fourth connecting portion connecting with the third connecting portion and a fixing portion fixed on the printed circuit board;
a device case; and
a device connector received and retained in the device case, the device connector comprising:
a third inner conductor with a lower contacting portion;
a third outer conductor retained in the device case; and
a third insulator securing the third inner contact in the third outer conductor;
wherein the first insulator swayably sits on the second insulator, the second connecting portion extends into the lower receiving cavity and connects with the first connecting portion, the lower contacting portion extends into the upper receiving cavity and connects with the mating portion, and the first connecting portion is able to sway relative to the second connecting portion and the third connecting portion is able to sway relative to the fourth connecting portion when the first insulator sways relative to the second insulator.

17. The coaxial connector assembly as claimed in claim 16, wherein the second connecting portion has plural elastic arms to form an inserting hole, and the first connecting portion is needle-shaped and is inserted into the inserting hole.

18. The coaxial connector assembly as claimed in claim 17, wherein the elastic arms are spaced from an inside of the lower receiving cavity, and a length of the second inner conductor exposed in the lower receiving cavity is about two times a length of the second inner conductor embedded in the second insulator.
